(19) United States
(12) Patent Application Publication
(10) Pub. No.: US 2008/0273415 A1
(43) Pub. Date: Nov. 6, 2008

(54) APPARATUS AND METHOD FOR PRODUCING CONCRETE

(75) Inventors: Richard THORNTON, Henderson, NV (US); Craig Lawson, Fullerton, CA (US); Chris Crain, Jasper, IN (US)

Correspondence Address: KNOBBE MARTENS OLSON & BEAR LLP, 2040 MAIN STREET, FOURTEENTH FLOOR, IRVINE, CA, 92614, US

(73) Assignee: Jonel Engineering, Fullerton, CA (US)

(21) Appl. No.: 12/114,451

(22) Filed: May 2, 2008

Related U.S. Application Data
(60) Provisional application No. 60/915,598, filed on May 2, 2007.

(51) Int. Cl. B28C 5/38

(52) U.S. Cl. 366/3; 366/18; 366/10; 366/8

(57) ABSTRACT

Apparatus and methods produce substantially continuous batches of high-strength concrete. Portland cement, flyash, sand, water, and concrete chemical additives are premixed in a multi-stage process, prior to final mixing with the coarse aggregates. In sequence, the complete mixing process includes: 1) a twin-shaft compulsory mixer to blend the materials, then disposing the mixture into; 2) a horizontal screw conveyor, continuously mixing as the mixture passes through the housing, thereby disposed simultaneously with the coarse aggregates into; and 3) the mixer concrete delivery truck, wherein the concrete is mixed further.

### CROSS-REFERENCE TO RELATED APPLICATIONS

This application claims priority from U.S. Provisional No. 60/915,598, filed May 2, 2007, the entire contents of which are incorporated herein by reference.

### FIELD OF THE INVENTION

This invention relates generally to an apparatus and methods for producing ready-mixed concrete and more particularly to an apparatus and methods for continuous production of ready-mixed concrete.

### DESCRIPTION OF THE RELATED ART

In the production of concrete, a variety of materials must be measured and mixed. The process can take an extensive period of time, causing delays in delivery. Attempts to accelerate the process can potentially reduce the quality of the concrete. Therefore, fast and high quality methods and apparatuses for producing concrete are needed.

### SUMMARY OF THE INVENTION

In one embodiment, apparatuses and methods produce substantially continuous batches of high-strength concrete. Accordingly, concrete is ready to be pumped into a concrete truck immediately after a preceding concrete truck has been loaded with concrete. Pre-measured cement, flyash, sand, and water are mixed together at high speed, for a short duration in a stationary mixer. The mixture is then discharged into a transition hopper above a horizontal screw conveyor along with the larger aggregate. The mixture progresses through its final mixing stages as it discharges to the truck.

While the mixture is going through its final mixing stages, the next batch of pre-measured materials enter the mixer to be blended. The blending time is equal to or less than the time it takes to process the initial mixture through the horizontal screw conveyor, thereby, reducing any time span between batches.

Raw materials are weighed in their respective vessels and then discharged to intermediary “holding” hoppers. The materials stay held in their hoppers until the mixer is ready to receive them. Once the weighing vessels are purged, they become ready for the next weigh cycle. Therefore, the process remains continuous from batch to batch and allows for different mix proportions and batch sizes.

Cement reduction is provided by means of premixing the cement, sand, and water separately from the course aggregates, in the twin-shaft mixer. This allows the cement to become more hydrated and offer better adhesion when coming into contact with the course aggregates. Embodiments of this invention produce high-strength ready-mixed concrete, and are capable of reducing the relative quantity of cement per batch. Another aspect of these embodiments is to decrease the overall mixing time for each batch. Another aspect is to provide continuous output of concrete.

In one aspect of the invention, an apparatus for producing substantially continuous batches of high-strength concrete is provided, said apparatus utilizing a multi-stage mixing process so the concrete is ready to be pumped into a truck immediately after a preceding concrete truck has been loaded with concrete. The apparatus includes sand and rock scales adapted to reverse-weigh a predetermined quantity of sand and rock, and discharge said sand and rock onto respective sand and rock conveyors. The apparatus can also include sand and rock hoppers to receive and hold sand and rock from the respective conveyors. The apparatus can further include scales for cement, flyash, and water, that are adapted to receive and hold these materials from cement and flyash silos and a water supply until a predetermined weight of each ingredient is reached. A control system responsively connects to the scales and hoppers, and is adapted to cause the sand hopper, cement scale, flyash scale, and water scale to release their contents into a mixer and to subsequently refill for a subsequent batch. Adapted to receive mixed ingredients from the mixer can be a horizontal screw conveyor, which further mixes said ingredients to form a mixture, and to expel said mixture at an elevated pressure to a transition cone. The transition cone is positioned to receive the mixture from the horizontal screw conveyor and the rock from the rock hopper and convey said mixture and rock to a mixer truck at high speed. The apparatus can enable successive loading and mixing of measured quantities of cement, flyash, sand, rock, and water while the conveyor is delivering a mixed batch to the mixer truck so that successive batches of concrete are conveyed by the conveyor in time to be loaded into successive mixer trucks without any appreciable delay between the loading of each successive mixer truck.

In another aspect of the invention, an apparatus to produce substantially continuous batches of high-strength concrete utilizing a multi-stage mixing process is provided. The apparatus can include a twin shaft compulsory mixing unit that operates to blentd pre-measured cement, flyash, sand, water, and chemical additives to form a mixture. A horizontal screw conveyor can be proximal to the mixing unit, receiving the contents thereof and further blending the mixture by means of an auger as the mixture transfers from an inlet to an outlet. Adjacent the screw conveyor is a truck charging chute with a port located in the wall. Coarse aggregates can be disposed and collide with the mixture as both enter the chute. These can then dispose to a mixer truck wherein mixing can conclude.

In yet another aspect of the invention, a method of producing substantially continuous batches of concrete is provided. Cement, water, and sand are mixed to form a first concrete mixture. The mixture is discharged into a horizontal screw conveyor. The first concrete mixture is forced by the horizontal screw conveyor into a final mixing stage with larger aggregates such as rocks and into a first concrete truck; and meanwhile, a second concrete mixture is mixed. Substantially immediately after the horizontal screw conveyor forces the first concrete mixture into the final mixing stage and into the first concrete truck, the second concrete mixture discharges into the horizontal screw conveyor. Substantially immediately after the first truck is loaded, the second truck is loaded.

In an additional aspect of the invention, an apparatus to produce substantially continuous batches of high-strength concrete is provided. The apparatus includes at least one aggregate container responsively coupled to a control system. The container is adapted to measure and discharge a quantity of aggregate by a reverse weighing process according to the control system and to report a status to the control system. At least one intermediate container generally adjacent the aggregate container is adapted to receive and discharge aggregate from the aggregate container according to the control system. The apparatus further includes at least one cement container responsively coupled to the control system. The at least one cement container is adapted to measure and discharge a quantity of cement according to the control system and to report a status to the control system. The intermediate container and the cement container are adapted to discharge their contents to a mixer. While the mixer is in operation the apparatus is adapted to begin measuring new portions of aggregate and cement.

In a further aspect of the invention, an apparatus to produce substantially continuous batches of high-strength concrete is provided. The apparatus can include a mixing unit adapted to blend at least cement, water, and aggregate. Generally adjacent the mixing unit can be a translating means for receiving an output from the mixing unit and disposing of said output at an elevated pressure. Generally adjacent the translating means can be a truck charging chute adapted to accept and combine an output from the translating means and a quantity of aggregate and dispose said output and aggregate to a mixer truck.

In yet another aspect of the invention a method of producing substantially continuous batches of high-strength concrete is provided. Cement, water, and aggregate are mixed to form a first batch of at least partially mixed concrete. The first batch discharges into a horizontal screw conveyor, from which it is dispatched to a large aggregate mixing vessel along with a first quantity of large aggregate and discharging said mixture to a first concrete receiving truck. A second batch of concrete is mixed at the same time that the first batch is in the horizontal screw conveyor. This second batch is discharged into the horizontal screw conveyor substantially immediately after said horizontal screw conveyor has discharged the first batch of concrete into the large aggregate mixing vessel.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

The foregoing and other features, aspects and advantages of the present invention are described in detail below with reference to the drawings of various embodiments, which are intended to illustrate and not to limit the invention. The drawings comprise the following figures in which:

FIG. 1 illustrates a flow diagram of an embodiment concrete batch plant;

FIG. 2 is a side elevational view of an embodiment of a concrete batch plant;

FIG. 3 is a front elevational view of the concrete batch plant of FIG. 2;

FIG. 4 is an elevational view of the concrete batch plant of FIG. 3 taken along lines 4-4;

FIG. 5 is an elevational view of the concrete batch plant of FIG. 3 taken along lines 5-5;

FIG. 6 is an elevational view of the concrete batch plant of FIG. 3 taken along lines 6-6;

FIG. 7A is a rear view of an embodiment horizontal screw conveyor and transition hopper;

FIG. 7B is a side view of the horizontal screw conveyor and transition hopper of FIG. 7B;

FIGS. 8A and 8B are side views of a transition cone with a shroud open and closed, respectively;

FIGS. 9A, 9B, and 9C illustrate one embodiment of a twin shaft concrete mixer;

FIG. 10 illustrates a time line corresponding to an embodiment method of producing high-strength concrete; and

FIG. 11 illustrates a flow diagram of another embodiment concrete batch plant.

### DETAILED DESCRIPTION OF THE PREFERRED EMBODIMENT

The disclosure herein provides systems and methods for high-strength concrete. The disclosure herein additionally provides systems and methods for continuous production of batches of concrete. A computer control system can be used to coordinate the various elements of a concrete batch plant and accelerate production. Further, elements can be provided to the batch plant to cause the concrete to discharge to a mixer truck at high pressure and speed, accelerating the delivery and transport of the concrete.

The concrete produced by the systems and methods disclosed herein can have a strength up to approximately 20 percent greater than concrete formed with prior art concrete technologies using the same ingredient proportions. Thus, the present invention can potentially provide stronger concrete at a faster rate.

### Plant Form & Function

A computer control system 33 is connected to each of the plurality of components of the batch plant. The computer control system 33 can comprise a server, a desktop computer, a laptop computer, or any other computer processing device with similar capability, or more than one of such devices. Control system 33 can also comprise computer readable media programmed to activate the components of the batch plant in the appropriate sequence to achieve substantially continuous production of batch concrete, so that each concrete truck can be filled immediately after a preceding truck has been filled. Further, the computer control system 33 can comprise various connections, such as electrical connections, capable of relaying commands and information between the components of the batch plant and the computer control system. Further, the control system 33 can comprise mechanical connections between various elements of the plant to supplement or replace electronic parts. The procedures by which the computer control system 33 can achieve substantially continuous production are described herein. It should generally be understood that although not all steps described herein are explicitly described as being controlled by the computer control system 33, each of these steps can be controlled by the computer control system in at least some embodiments.

The computer control system 33 can further comprise a user interface. The user interface can comprise, for example, a keyboard, mouse, or other user inputs, as well as a visual display, speakers, lights, a belt start horn, and other human perceivable outputs. The control system 33 can allow a user to fully or partially control embodiments of a multi-stage batch plant described herein. Further, the control system 33 can allow multiple users to control multiple parts of the process simultaneously, potentially from different locations in the plant, as further described herein.

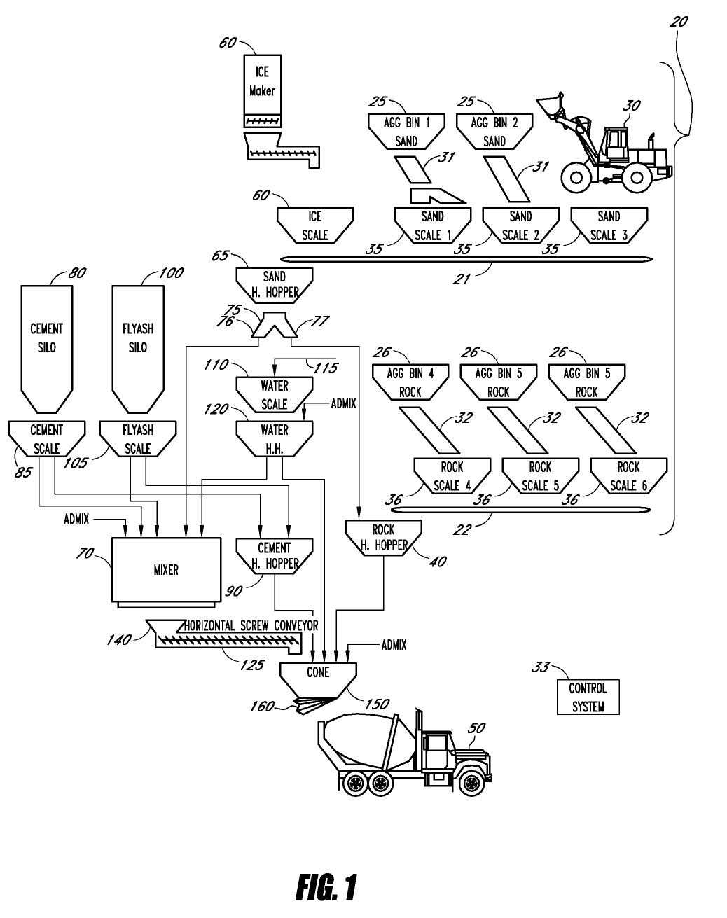

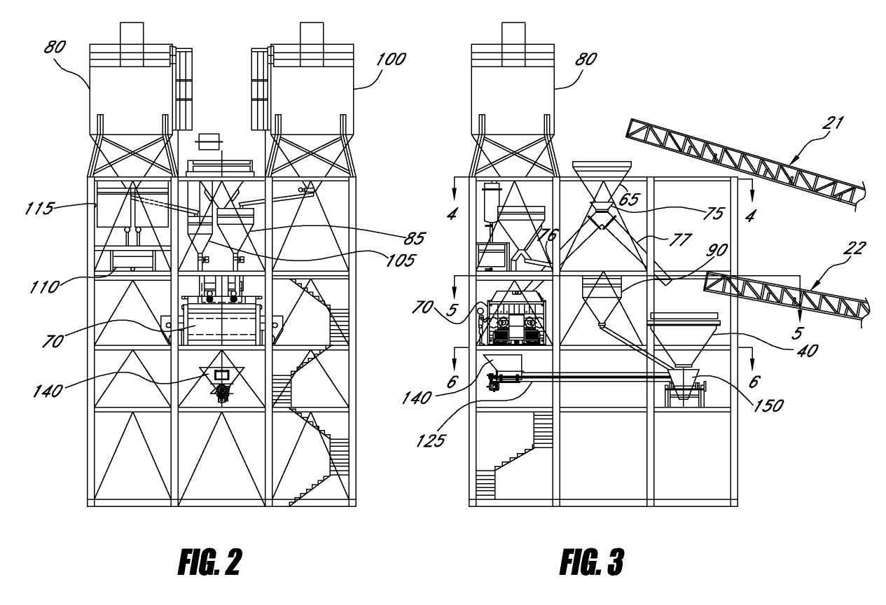

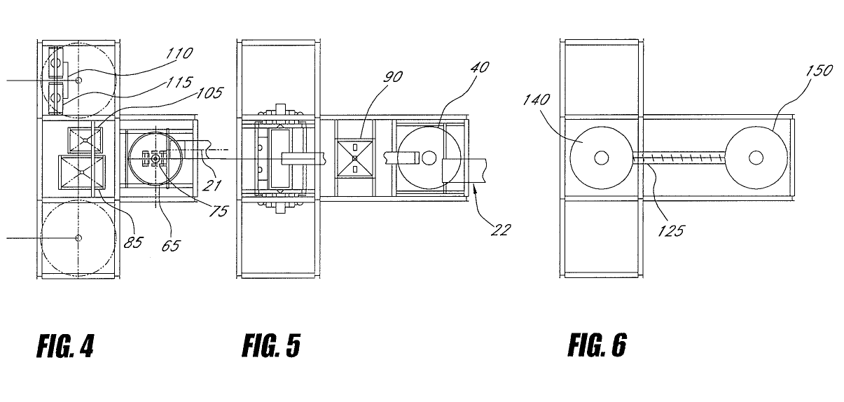

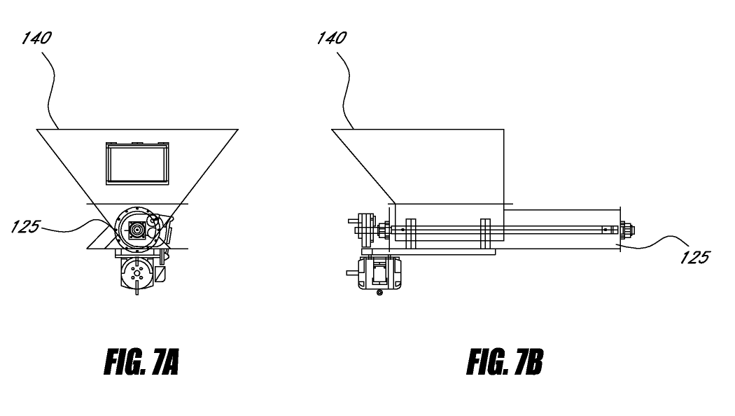

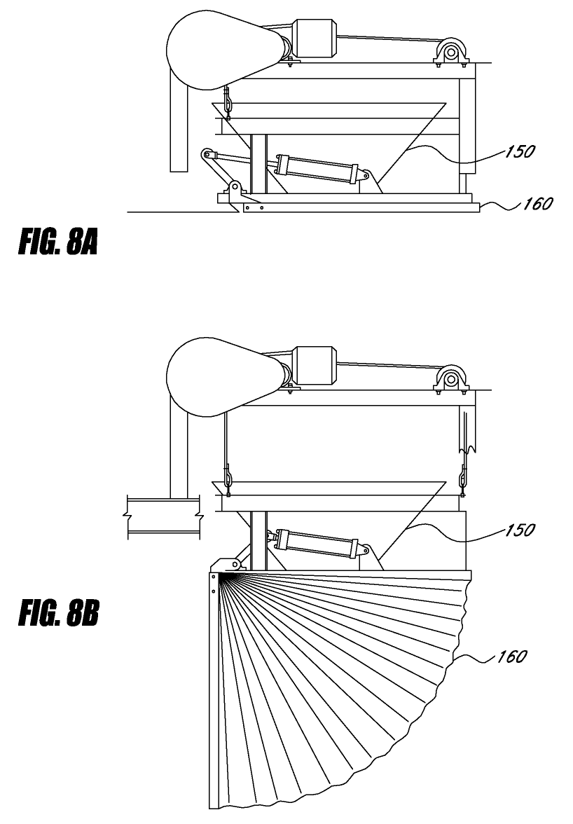

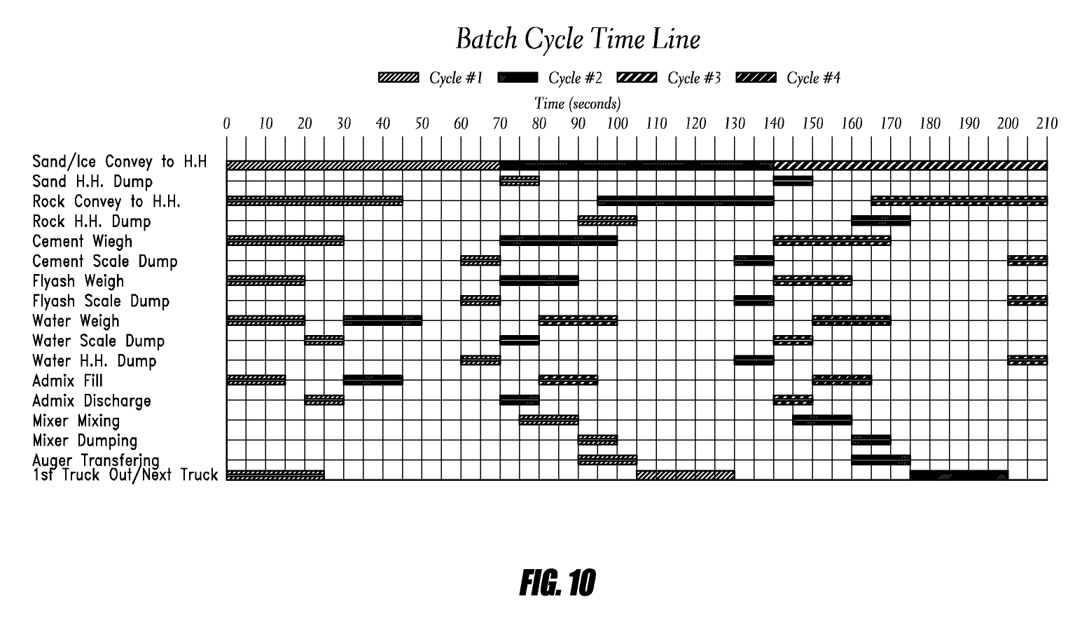

One embodiment of a multi-stage batch plant is shown schematically in FIG. 1, and in detail in the FIGS. 2-9. An aggregate section 20 and an icemaker 61 are located at ground level, near the back of sand and rock conveyors 21, 22. In the aggregate section 20, the sand and rock can be transferred from stockpiles to their respective loading bins 25, 26 using a front-end loader 30. Individual feed conveyors 31, 32 can transfer the sand and rock aggregates from their respective bins 25, 26 to their respective weigh scales 35, 36 so long as the scale(s) are empty or that enough residual capacity remains. This transfer can be accomplished using the force of gravity or by other mechanisms such as a conveyor. As depicted, the batch plant can comprise multiple bins 25, 26, and scales 35, 36 for both the sand and rock aggregates. This can be advantageous, for example, when multiple types of sand and/or rock are used for a given batch of concrete. The separate bins 25, 26 and scales 35, 36 allow the different types of sand and/or rock to be measured simultaneously instead of in series, reducing measuring time.

Further, as will be apparent to those skilled in the art from the disclosure herein, the sand and rock take different paths through the batch plant. In some embodiments it will be desirable for at least one type of sand or rock to pass through the batch plant with the other (e.g. a certain type of sand going with the rock aggregate). The batch plant can thus be modified in other embodiments such that a sand scale 35 and sand bin 25 are positioned to discharge sand onto the rock conveyor 22. Similar repositioning may be accomplished with the rock bins and scales 26, 36 and the sand conveyor 21.

The aggregate scales 35, 36 can be advantageously outfitted with high-level indicators to manage their maximum capacity and the aggregates are held in these scales until a batch sequence is initiated. Any feed conveyors running when a batch is started are halted, preserving an integrity of the measured weight of material transmitted from the scales 35, 36. The scales 35, 36 can discharge in a “reverse weighing” process, wherein discharging stops when the scale attains a measurement that is the difference of the weight before discharging commenced and the desired weight of aggregates discharged. In other embodiments the scales 35, 36 can be filled to a desired weight above their tare value, and then discharged to the conveyors 21, 22. Notably, the steps of weighing and then discharging may take a longer time than the single discharge in the “reverse weighing” process.

The rock conveyor 22 transfers the coarse aggregates (rock) from the scales 36 to the rock holding hopper 40. The aggregate can be held here until a concrete truck 50 is ready to receive it.

Some embodiments of the batch plant can further comprise an icemaker 61. Ice is transferred from the icemaker 61 into the ice scale 60, when a batch sequence is initiated. Filling is halted when the scale attains a preset weight. The scale discharges until it reaches its tare value.

The sand conveyor 21 transfers the fine aggregates (sand) and ice, from the scales 35 and 60 to the sand holding hopper 65. The materials can be held here until the mixer 70 or concrete truck 50 is ready to receive them.

A diverter 75 can be positioned underneath the sand holding hopper 65. The diverter 75 directs the path of the contents of the sand holding hopper 65 to the mixer 70 through diverter arm 76 or the rock holding hopper 40 through diverter arm 77. The proportion of material going in each direction can be controlled by the computer control system 33, via any generally known diverting mechanism. In some embodiments the sand holding hopper 65 may be positioned at a height substantially above the mixer 70, such as approximately 10 to 12 feet. In these embodiments, the diverter 75 can lead to a chute through which the contents can fall a substantial distance, gaining speed prior to entering the mixer 70. The chute may further be substantially vertical when entering the mixer 70, facilitating mixing and reducing material build-up.

Cement is transferred from a cement silo 80 into the cement scale 85, when a batch sequence is initiated. Filling is halted when the scale attains a preset weight. The scale can then discharge until it reaches its tare value and the contents are diverted to either the mixer 70 or the cement holding hopper 90 via another diverter (not shown).

Flyash is transferred from a flyash silo 100 into the flyash scale 105, when a batch sequence is initiated. Filling is halted when the scale attains a preset weight. The scale can then discharge until it reaches its tare value and the contents are diverted to either the mixer 70 or the cement holding hopper 90 via another diverter (not shown).

Unless directed otherwise, by means of diverters (controlled by the computer control system 33), the cement holding hopper 90 can assume the cumulative contents of both the cement scale 85 and flyash scale 105. The contents of the cement holding hopper 90 are held here until the truck 50 is ready to receive them.

The water scale 110 can be filled to a preset value from the main water supply 115, when a batch sequence is initiated. The water holding hopper 120 accumulates water from the water scale 110 and is held in hopper 120 until the mixer 70 or concrete truck 50 is ready to receive it. When depositing water to the concrete truck 50, the water holding hopper discharges until it reaches its tare value. When depositing water to the mixer, the water holding hopper can optionally discharge until it reaches a value above its tare value so as to hold back a percentage of its contents to later rinse the mixer or to pass along to the concrete truck 50.

Unless directed otherwise, by diverters (controlled by the computer control system 33), the mixer 70 can receive the cumulative contents of the cement scale 85, the flyash scale 105, the sand holding hopper 65, and the water holding hopper 120. The mixer 70 can then be engaged as part of the batch sequence and extends for a duration suitable to blend the materials, as dictated by the computer control system 33. The mixed contents are held here until a horizontal screw conveyor 125 is ready to receive them.

The horizontal screw conveyor 125 can comprise a portion proximal to the mixer 70 and a portion distal from the mixer 70. At the proximal portion the horizontal screw conveyor 125 can be generally adjacent to a transition hopper 140 which facilitates the transfer of material into the conveyor. Further, the proximal portion of the horizontal screw conveyor can comprise open flights, allowing further mixing of the material. The distal portion of the screw conveyor may comprise closed flights. The horizontal screw conveyor 125 engages as part of the batch sequence and extends for duration suitable to transfer the contents of the mixer 70 to the truck 50. The horizontal screw conveyor 125 can further run at a speed or have an angle of inclination sufficient to accelerate its contents and discharge them at high speeds. Discharging the contents at high speeds can substantially reduce the time required to fill a mixer truck from approximately 2 minutes in prior art batch plants to approximately 90 seconds, or 45 seconds in some embodiments. Other embodiments can be used to discharge the concrete at pressure, including a progressive cavity pump 130 as depicted in FIG. 11. In some embodiments, multiple elements for the conveying and discharging of concrete can be used. For example, two horizontal screw conveyors 125 or progressive cavity pumps 130, 130′ can be used such that both operate at the same time, or in other embodiments each processes alternating batches. In other embodiments, more than two elements can be used.

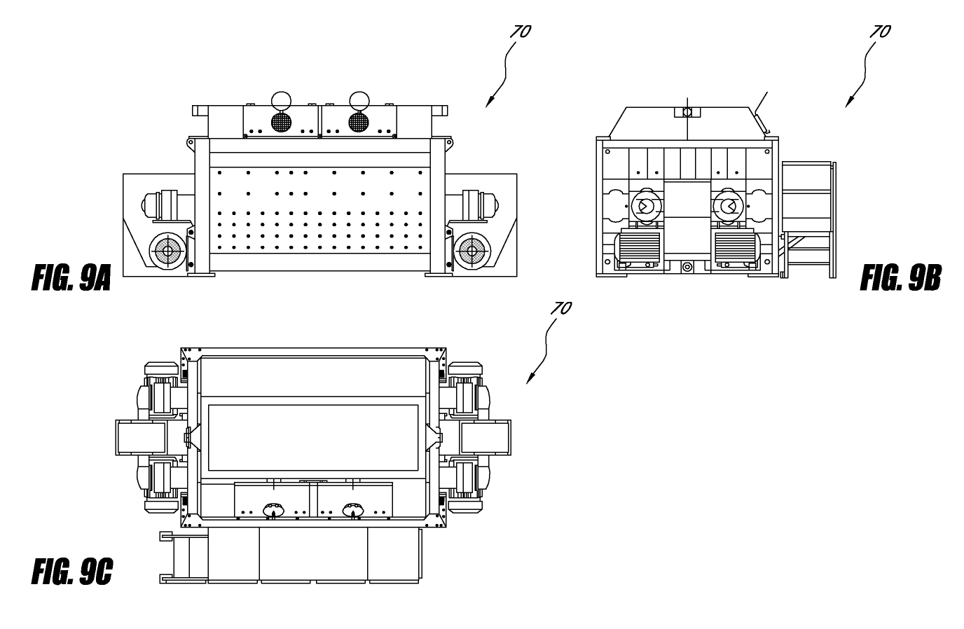

To facilitate transfer of concrete to the truck 50, the batch plant can further comprise a transition cone 150. The transition cone 150 can receive contents from the horizontal screw conveyor 125, the cement holding hopper 90, the water holding hopper 120, and the rock holding hopper 40. The transition cone 150 can further comprise a shroud 160 that can fan out to reduce atmospheric discharges of concrete material during loading of the mixer truck 50, as shown in FIGS. 8A and 8B.

In addition to the elements described above, the batch plant may comprise points for the addition of various other ingredients, as shown in FIG. 1 and denoted as “admix”. The admix can include chemicals that change the rate of hydration, workability, color, propensity for corrosion, strength of the concrete to be produced, and/or other properties. These chemicals can be added directly to the mixer 70, water holding hopper 120, transition cone 150, and/or at any other desirable point in the batch plant.

Further, the batch plant may comprise a number of additional sensors. The sensors can measure, for example, the moisture content of the sand in the sand bins 25 or scales 35. Such sensors for moisture content may comprise one or more microwave moisture sensors. As another example, the batch plant can comprise sensors to measure the characteristics of the horizontal screw conveyor 125 and/or mixer 70 such as the running voltage, current, power consumption, rotational speed, and other characteristics. Further, as discussed above, the batch plant can comprise scales to measure the weights of various ingredients. Alternatively, the quantity of ingredients added may be measured by volume, electrical resistance, or any other method known in the art. In some embodiments it will further be desirable to measure various atmospheric characteristics such as temperature and humidity. A further sensor can indicate the position of a mixer truck ready to receive concrete, such as with a scale beneath the point of loading or by a user actuated input such as a button. As discussed further herein, each sensor can report to the computer control system 33, which can then use this information to optimize the quality, quantity, and speed of concrete produced by the batch plant.

### Description of a Process for Preparing High-Strength Concrete

In an example embodiment of a process for producing substantially continuous batches of high-strength concrete, preliminary steps may first be performed. The various hoppers 40, 65, 90, 120, 140, 150, scales 35, 36, 60, 85, 105, 110, conveyors 21, 22, 125, and mixer 70 may be emptied, cleared, and/or cleaned. One or more front-end loaders 30 can fill the bins 25, 26 to a desired level sufficient for at least one batch of concrete. Further, the silos 80, 100 and icemaker 61 can be filled and the main water supply 115 can be verified.

An embodiment batch plant can be initiated with use of the computer control system 33. A user can actuate the computer control system 33 and indicate the properties of one or more batches of concrete to be produced, such as the desired quantities of each ingredient for example. This can then form a queue in the computer control system 33 of batches to be prepared by the batch plant. Further batches may be added to the queue and reordered according to commands from the user via the user inputs.

Prior to or at the same time as formation of the queue, the computer control system 33 can, upon actuation by the user, initiate the individual feed conveyors 31, 32 to fill the sand and rock scales 35, 36. To prevent over-filling, the high-level indicators on the sand and rock scales 35, 36 can send an electrical signal to the individual feed conveyors 31, 32 when the scales approach a maximum capacity. This signal can pass directly to the individual feed conveyors 31, 32 (the signal constituting part of the computer control system 33), or alternatively can travel first to a computing center which processes the information and in response generates another signal causing the individual feed conveyors 31, 32 to temporarily stop. A similar signal from the high-level indicators can indicate when the scales 35, 36 are below a maximum capacity, causing the individual feed conveyors 31, 32 to restart.

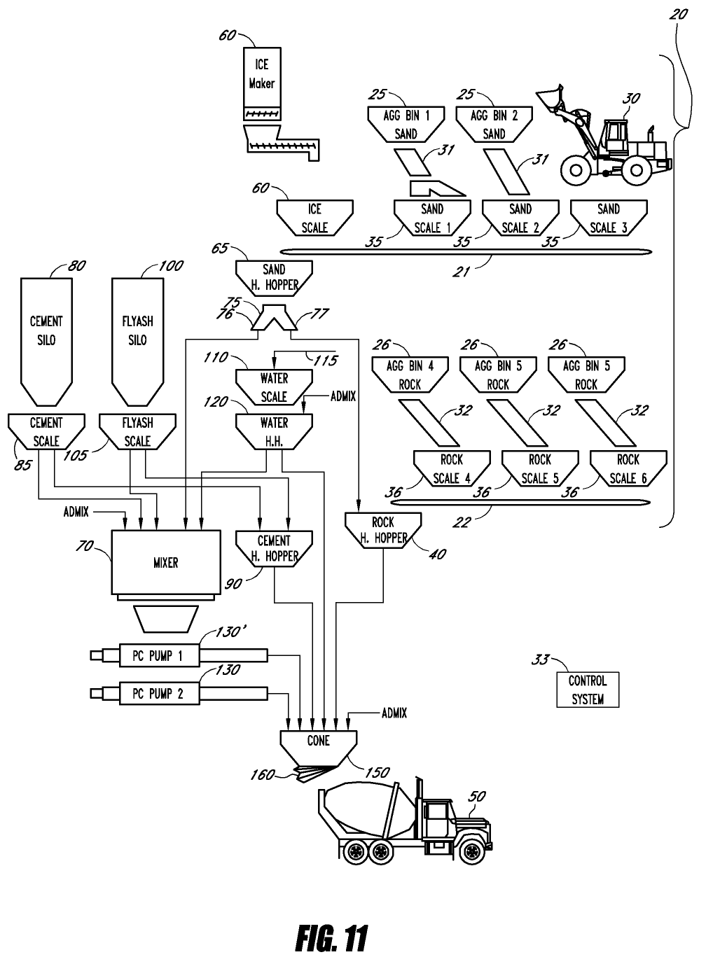

Each batch cycle described hereafter, will be numerically identified, in the order initiated. A more specific embodiment is depicted by the time line in FIG. 10. Initial start-up assumes all weighing vessels 35, 36, 60, 85, 105, 110 holding hoppers 40, 65, 90, 120 mixer 70, and the horizontal screw conveyor 125 is empty. Additionally, the aggregate scales 35, 36 are filled to capacity, at least one concrete truck 50 is ready to receive materials, and additional concrete trucks may be in queue. Furthermore, all diverters 75 (and those not shown) are in position to direct the contents of the sand holding hopper 65, cement scale 85, flyash scale 105, and water holding hopper 120 to the mixer 70. The cement holding hopper 90 will not be used for the process described here. However, it will be clear to those of skill in the art from the disclosure herein that the cement holding hopper 90 could be used to form concrete having different properties in other embodiments.

When the first concrete batch #1 is initiated by computer control system 33, cement, flyash, and water can be measured into their respective scales 85, 105 and 110 (as well as, optionally, ice and ice scale 60). Concurrently, the rock conveyor 22 is activated to transfer material from its related scales 36 into the rock holding hopper 40, where the rock is held, and the sand conveyor 21 is activated to transfer material from its related scales 35 into and through the sand holding hopper 65 to the mixer 70.

The proportions of material can be controlled by the scales in cooperation with the computer control system 33. For example, the aggregate scales 35, 36 can use the “reverse weighing” process to release material until a difference between the scale's current measured weight and the measured weight before discharging approximately equals the weight of a desired amount of aggregate. At this point, the computer control system 33 can receive information indicating such from the aggregate scales 35, 36 and respond by indicating that they stop discharging material. Upon this occurrence, the computer control system 33 can also restart the individual feed conveyors to refill the aggregate scales 35, 36 if desired. Further, the computer control system 33 can use an internal time-keeping mechanism, a conveyor speed, and a conveyor distance to calculate a time sufficient to transfer the discharged aggregate to the respective hoppers 65, 40.

Similarly, the computer control system 33 can cause the cement and flyash silos 80, 100 and the icemaker 61 and main water supply 115 to discharge their respective materials into their respective scales 60, 85, 105, 110. When a scale measures a predetermined weight above its tare value, the computer control system 33 can terminate the filling process. In other embodiments, the ice, cement, flyash, and/or water can also be measured by a “reverse-weighing” method.

While the aggregates are being conveyed to their hoppers 65, 40, the cement, flyash, and water scales 85, 105 and 110 can attain their preset weights, as described above. The water scale 110 being first to weigh up, can discharge to the holding hopper 120. The water scale 110 can then accept water for the second concrete batch #2. In other embodiments, the water scale 110 can accept a second portion of water to be provided directly to the transition cone 150 with batch #1, transmit that to the water holding hopper (once the previous portion of water has emptied), and then receive water for batch #2. After all the materials are measured, and within a similar span of time, the cement scale 85 and flyash scale 105 attain their present weights and the contents of cement scale 85, flyash scale 105, and the water holding hopper 120 discharge into the mixer 70. Similarly, the contents of the sand holding hopper 65 also can discharge into the mixer 70 substantially immediately after the other ingredients to facilitate mixing and reduce material build-up in the mixer. Each of these steps can be coordinated by the computer control system 33, manipulated by the computer control system to produce a specific form of concrete, and monitored by the computer control system to measure the adherence of the produced concrete to desired characteristics.

In this general time period, the following conditions can exist:
1. The mixer 70 has accumulated material and has commenced primary mixing for batch #1.
2. The sand and rock scales 35, 36 are full and ready for batch #2.
3. The sand holding hopper 65 is empty and is now filling for batch #2.
4. The water scale 115 has been filled for batch #2.
5. The cement scale 85 is empty and is now filling for batch #2.
6. The flyash scale 105 is empty and is now filling for batch #2.
7. The rock holding hopper 40 is full and ready to discharge material for batch #1.
8. The horizontal screw conveyor 125 is ready to receive batch #1 from the mixer 70.

The computer control system 33 can measure the power drawn by mixer 70 to determine when mixing is complete. The power drawn by the mixer 70 at completion can be calculated from the ingredients in the batch, the desired properties of the final concrete, and the properties of the mixer. Afterward, the mixer 70 is caused to begin discharging its contents into the transition hopper 140, above the horizontal screw conveyor 125, and the horizontal screw conveyor is activated. By this time, the sand holding hopper 65, cement scale 85, flyash scale 105, and water holding hopper 120 are holding the materials for batch #2. In some embodiments, the mixer 70 can mix 6 cubic yards of material within 15 seconds.

Preferably, after the mixer 70 has completed discharging and its output gate is closed, the mixer 70 accepts the pre-measured contents for batch #2 from the cement and flyash scales 85, 105 and from the sand and water holding hoppers 65, 120. The mixer 70 can comprise various sensors similar to those described herein to indicate that it is empty, causing the second batch ingredients to be introduced. In other embodiments, a predetermined time for emptying can be known, and used to determine when the mixer 70 should be ready for the next batch. At approximately the same time, the horizontal screw conveyor 125 can begin discharging into hopper 150 and the rock holding hopper 40 can begin depositing its contents into hopper 150. In some embodiments, the horizontal screw conveyor 125 may begin discharging sooner or later than the refilling of the mixer 70, depending on the time necessary to travel through the horizontal screw conveyor and other considerations. Again, each of these steps can be coordinated by the computer control system 33, manipulated by the computer control system to produce a specific form of concrete, and monitored by the computer control system to measure the adherence of the produced concrete to desired characteristics.

In this general time period, the following conditions can exist:
1. The mixer 70 has accumulated material and has commenced primary mixing for batch #2.
2. The sand scales 35 are full and ready for batch #3.
3. The rock scales 36 are full and ready for batch #2.
4. The sand holding hopper 65 is empty and is now filling for batch #3.
5. The water scale 110 has been filled for batch #3 and releases to the water holding hopper 120.
6. The cement scale 85 is empty and is now filling for batch #3.
7. The flyash scale 105 is empty and is now filling for batch #3.
8. The rock holding hopper 40 is discharging material for batch #1 and near empty.
9. The rock conveyor 22 starts transferring aggregates for batch #2, to the rock holding hopper 40. This conveyor stops after a set duration if holding hopper 40 is not empty.
10. The horizontal screw conveyor 125 is pumping batch #1 to the truck.

As the horizontal screw conveyor 125 collects the premixed material from the mixer 70, it can further blend the material with an auger, as the material transfers through the screw conveyor's housing to provide a secondary mixing. When the horizontal screw conveyor 125 delivers its contents to the transition cone 150, the contents of the rock holding hopper 40 are deposited into same. The collision of these aggregates on the mixed material adds the final mixing action (turbulence), as the materials enter the truck 50 through the cone 150. As discussed above, the horizontal screw conveyor 125 can discharge its contents at an elevated pressure and speed, facilitating the mixing of the concrete and rock and accelerating the filling of the truck 50. For example, the horizontal screw conveyor 125 can discharge its contents at a pressure of 15 psi, or at a flow rate of 3.6 cubic feet per second or 1615 gallons per minute.

The computer control system 33 can measure the power drawn by the horizontal screw conveyor 125 to determine when pumping is complete. Likewise, the computer control system 33 can cause the contents of the rock holding hopper 40 to be fully deposited in the cone 150, as regulated by a governed flow rate. The flow rate from the rock holding hopper 40 can be chosen to generally match the flow rate from the horizontal screw conveyor 125, or vice versa. After pumping has halted, the control system 33 signals the concrete truck 50 to pull out of position to provide ingress for the next truck 50. Said signal can comprise a horn, light, or other human-perceivable output.

While the next mixer truck 50 gets positioned, the mixer 70 can commence discharge of batch #2 to the horizontal screw conveyor 125. Concurrently, the horizontal screw conveyor can engage and the rock holding hopper 40 can fill, with aggregates for batch #2—depositing them to the next truck 50 soon after.

As the horizontal screw conveyor 125 proceeds, the mixer 70 again empties and receives the pre-measured contents for batch #3—premixing and holding the batch until the horizontal screw conveyor 125 is ready to receive it. At the same time, empty scales and holding hoppers accept their respective materials for batch #4.

Until the process is interrupted by manual intervention, electrical failure, or mechanical failure, continuous batches of concrete can be produced. While batch #1 is discharged by the horizontal screw conveyor 125 and rock holding hopper 40 to the mixer truck 50, batch #2 can be mixing in the mixer 70 with final aggregates for batch #2 in transit, on the rock conveyor 22 to the rock holding hopper 40. At the same time batch #3 can be pre-measured or measuring contents in the sand holding hopper 65, cement scale 85, flyash scale 105, water holding hopper 120, and rock scales 36.

Mixer trucks are signaled, by the control system 33, to translate position at the end of each batch. A short span of time is provided between the end of one batch and before the next batch of concrete begins pumping to allow the next truck to get positioned. The time between the end of discharging to the first truck and the beginning of the discharging to the second truck can be 70 seconds. However, the batch plant may on occasion require longer times, for example, on the initial batch.

Further modifications can be made to the batch plant and process described herein. In some embodiments changes can be made to account for a given unit or step taking longer than other units or steps that either operate contemporaneously or cannot start until the lagging unit/step is completed. For example, if a batch #1 requires a longer mixing time than usual than it can be held in mixer 70 a longer period of time. To promote faster turnover, the other units can continue ahead of the mixer 70, e.g. filling sand holding hopper 65 for a batch #2 and discharging the sand scales 35 to sand conveyor 21 with the ingredients for a batch #3 (but not actuating the sand conveyor 21 to prevent mixing of the ingredients for batches #2, 3 in sand holding hopper 65). The computer control system 33 can be adapted to control each unit of the batch plant independently to reduce idle time but not cause different batches to interfere.

To optimize the speed of production, the batch plant and process can be modified. At each step in the process the process generally will be only as fast as its slowest component. Thus, it will generally be desirable to modify the process to accelerate the slowest components. For example, in one embodiment described the sand and rock scales 35, 36 are provided at ground level and are raised to their respective hoppers 65, 40 by their respective conveyors 21, 22. The process of depositing to the conveyors 21, 22 and raising the material up these conveyors, along with the weighing process, can potentially comprise the slowest component. Thus it can be desirable to use a reverse-weighing process to accelerate these components. Similarly, if for example the supplying of cement to the mixer is the slowest component, a reverse-weighing process can be substituted. Other apparatuses and methods can be added to accelerate various steps, such as accelerating the conveyors 21, 22, shortening the chutes between each element, and other modifications.

Additionally, other embodiments of the computer control system 33 are possible. As described above, the computer control system 33 can comprise a single central computer that controls substantially all elements of the batch plant and to which substantially all sensors report. However, in other embodiments the computer control system 33 can comprise multiple computers, each cooperating or operating independently. For example, it may be desirable to provide a separate control system to the aggregate bins 25, 26 and scales 35, 36 for controlling the flow between the two. The scales 35, 36 could directly indicate to the separate control system 33′ when it has reached maximum capacity and the separate control system can then halt the flow from the aggregate bins 25, 26. It will be clear to those of skill in the art from the disclosure herein that this separate control system 33′ could comprise elements simpler than a computer, such as e.g. a single circuit. Further, the separate control system 33′ can act as a subcomponent of the computer control system 33.

As a further embodiment, the computer control system 33 can allow inputs from multiple users. An example includes a separate user controlling the discharging of the horizontal screw conveyor 125, the rock holding hopper 40, the cement holding hopper 90, and the water holding hopper 120 into the mixer truck 50. A user relatively near the transition cone 150 can control the opening of the respective elements of the batch plant and allow the discharge into the mixer truck 50 when in appropriate position. Meanwhile, a user at another location can manipulate the computer control system 33 to alter a queue therein or modify other parameters of the batch plant, including ingredients, quantities, and speeds.

### Description of the Primary Mixing Process

Prior art methods, proportioned amounts of cementitious material, aggregates, water, and chemical additives (admixtures) are blended simultaneously to prepare concrete. Regardless of the mixing method employed, low to moderate energy is expended along with extended mixing duration. The result is normally a moderate strength concrete. Additionally, concrete producers generally overcompensate the portion of cement to guarantee compressive strength requirements for their concrete.

The methods described herein can address the aforementioned issues. In one embodiment, cement, flyash, water, sand, and admixtures are blended at high-speed, with relatively higher energy requirements, for a shorter duration than conventional mixing techniques. By keeping the larger aggregates removed from the primary mix, a higher precision of raw material usage and mixing is achieved with a lower cumulative energy requirement, thereby eliminating waste.

Discovery and experiment have proved that depositing sand vertically into the mixer 70, as opposed to angularly, increases mixing dynamics and reduces material build-up. This minimizes the frequency of wash-down and cleaning cycles.

A precise cement to water ratio is generally desired to produce low slump high-strength concrete. Accurately measuring these materials from batch to batch further reduces any need to overcompensate for potential irregularities in the concrete. To achieve this, moisture probes can be installed in each aggregate bin 25, 26 and interconnected with the control system 33 for data acquisition. The aggregates can be adjusted in real-time for moisture content by moisture sensors. Through software encoded on a computer readable medium, the control system 33 can continuously or periodically monitor and determine the hydrated content of each aggregate. For any batch, the computer control system 33 can process this information to conclude precise moisture compensation. Based on the percentage dictated by the given moisture compensation, the control system 33 can reduce batched water and increase each batched aggregate content proportionally, while maintaining precise cement content. Typical tolerances are achieved by up to approximately 0.2% of surface and absorbed moisture in the aggregates.

Although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the novel methods and systems described herein may be embodied in a variety of other forms without departing from the spirit thereof. Accordingly, other combinations, omissions, substitutions and modifications will be apparent to the skilled artisan in view of the disclosure herein.

What is claimed is:

1. An apparatus for producing substantially continuous batches of high-strength concrete, utilizing a multi-stage mixing process, so the concrete is ready to be pumped into a truck immediately after a preceding concrete truck has been loaded with concrete, said apparatus comprising:
a sand scale adapted to reverse-weigh a predetermined quantity of sand and discharge said sand onto a sand conveyor;
a rock scale adapted to reverse-weigh a predetermined quantity of rock and discharge said rock onto a rock conveyor;
a sand hopper positioned to receive and hold sand from the sand conveyor;
a rock hopper positioned to receive and hold rock from the rock conveyor;
a cement scale adapted to receive and hold cement from a cement silo until a predetermined weight of cement is reached;
a flyash scale adapted to receive and hold flyash from a flyash silo until a predetermined weight of flyash is reached;
a water scale adapted to receive and hold water from a water supply until a predetermined weight of water is reached;
a control system connected to the scales and hoppers, and adapted to cause the sand hopper, cement scale, flyash scale, and water scale to release their contents into a mixer and to subsequently refill for a subsequent batch;
a horizontal screw conveyor adapted to receive mixed ingredients from the mixer and further mix said ingredients to form a mixture, and to expel said mixture at an elevated pressure; and
a transition cone positioned to receive the mixture from the horizontal screw conveyor and the rock from the rock hopper and convey said mixture and rock to a mixer truck at high speed;
wherein said apparatus enables successive loading and mixing of measured quantities of cement, flyash, sand, rock, and water while said conveyor is delivering a mixed batch to said mixer truck so that successive batches of concrete are conveyed by said conveyor in time to be loaded into successive mixer trucks without any appreciable delay between the loading of each successive mixer truck.

2. The apparatus of claim 1, wherein a batch of high-strength concrete sufficient to fill a mixer truck can be produced in 70 seconds.

3. The apparatus of claim 2, wherein the concrete has a strength increase of up to approximately 20 percent when compared to the same mix proportions of conventionally mixed concrete.

4. An apparatus to produce substantially continuous batches of high-strength concrete, utilizing a multi-stage mixing process, comprising:
a twin-shaft compulsory mixing unit, operating to blend pre-measured cement, flyash, sand, water, and chemical additives, forming a mixture;
a horizontal screw conveyor proximal to the mixing unit, wherein the mixture is further blended by means of an auger as the mixture transfers from an inlet to an outlet; and
a truck charging chute mounted adjacent to the horizontal screw conveyor, with a port located in the wall, wherein pre-measured course aggregates are disposed and collide with the mixture as both enter the chute and are disposed to a mixer truck, wherein mixing concludes.

5. The apparatus of claim 1 for continuous batching of concrete, comprising:
individual weighing vessels for quantitatively measuring cement, flyash, water, sand, and rock separately; and
individual intermediary holding vessels for receiving the deposition of said materials, except cement and flyash, which are accumulated in the same vessel, the configuration and placement of said weighing vessels and holding vessels being such that the flow of materials translates from vessel to vessel by gravity; and
an integral control system capable of controlling the weight measurement process for one batch cycle, while simultaneously controlling the mixing process for another batch cycle, thereby providing continuous output of said product.

6. A method of producing substantially continuous batches of concrete, comprising:
mixing cement, water and sand to form a first concrete mixture;
discharging said first concrete mixture into a horizontal screw conveyor;
mixing a second concrete mixture at the same time that said horizontal screw conveyor is forcing said first concrete mixture into a final mixing stage with larger aggregates and into a first concrete truck; and
discharging said second concrete mixture into said horizontal screw conveyor substantially immediately after said horizontal screw conveyor has forced the first concrete mixture into said final mixing stage and into said first concrete truck and
loading a second concrete truck with said second concrete mixture substantially immediately after said first truck has been loaded.

7. An apparatus to produce substantially continuous batches of high-strength concrete, comprising:
a control system;
at least one aggregate container responsively coupled to the control system, said container adapted to measure and discharge a quantity of aggregate by a reverse-weighing process according to the control system and to report a status to the control system;
at least one intermediate container responsively coupled to the control system and adapted to receive and discharge aggregate from the aggregate container according to the control system;
at least one cement container responsively coupled to the control system, said at least one cement container adapted to measure and discharge a quantity of cement according to the control system and to report a status to the control system; and
at least one mixer responsively coupled to the control system;
wherein the intermediate container and the cement container are adapted to discharge their contents to the mixer and the apparatus is adapted to begin measuring new portions of aggregate and cement while the mixer is in operation.

8. The apparatus of claim 7, wherein the control system comprises a computer readable medium.

9. The apparatus of claim 7, wherein the aggregate is sand.

10. The apparatus of claim 9, further comprising:
at least one rock container responsively coupled to the control system and adapted to measure and discharge a quantity of rock according to the control system and to report a status to the control system;
and at least one intermediate rock container responsively coupled to the control system and adapted to receive and discharge rock from the rock container according to the control system to the mixer.

11. The apparatus of claim 9, wherein multiple types of sand are used, and at least one aggregate container is associated with each type of sand.

12. The apparatus of claim 10, wherein multiple types of sand and rock are used, at least one aggregate container is associated with each type of sand, and at least one rock container is associated with each type of rock.

13. The apparatus of claim 7, further comprising a water container adapted to measure and discharge a quantity of water to the mixer.

14. The apparatus of claim 13, wherein the aggregate container further comprises one or more moisture-measuring devices.

15. The apparatus of claim 14, wherein the moisture measuring devices are adapted to report a moisture level to the control system, the control system using this to adjust the proportion of water in the mixer.

16. An apparatus to produce substantially continuous batches of high-strength concrete, comprising:
a mixing unit adapted to blend at least cement, water, and aggregate;
a translating means, located generally adjacent the mixing unit, for receiving an output from the mixing unit and disposing of said output at an elevated pressure; and
a truck charging chute generally adjacent the translating means adapted to accept and combine an output from the translating means and a quantity of aggregate and dispose said output and aggregate to a mixer truck.

17. The apparatus of claim 16, wherein the translating means comprises a horizontal screw conveyor.

18. The apparatus of claim 16, wherein the translating means comprises a progressive cavity pump.

19. The apparatus of claim 16, wherein the aggregate in the mixing unit is sand.

20. The apparatus of claim 16, wherein the aggregate added in the truck charging chute is rock.

21. The apparatus of claim 16, wherein the aggregate is dropped into the mixer from an elevated height of approximately 10 to 12 feet.

22. The apparatus of claim 16, wherein the apparatus is adapted to discharge high-strength concrete to the mixer truck at a flow rate of at least approximately 3.6 cubic feet per second.

23. The apparatus of claim 16, wherein the mixing unit blends the ingredients to form a high-strength concrete within approximately 15 seconds.

24. The apparatus of claim 17, wherein the horizontal screw conveyor comprises open-flights in a proximal portion.

25. A method of producing substantially continuous batches of high-strength concrete, comprising:
mixing cement, water, and aggregate to form a first batch of at least partially mixed concrete;
discharging said first batch of concrete into a translating means;
discharging said first batch of concrete from the translating means to a large aggregate mixing vessel along with a first quantity of large aggregate and discharging said mixture to a first concrete receiving truck;
mixing a second batch of concrete at the same time that the first batch is in the translating means; and
discharging the second batch of concrete into the translating means substantially immediately after translating means has discharged the first batch of concrete into the large aggregate mixing vessel.

26. The method of claim 25, wherein the translating means is a horizontal screw conveyor.

27. The method of claim 25, wherein the translating means is a progressive cavity pump.

28. The method of claim 25, wherein the aggregate is sand.

29. The method of claim 25, wherein the large aggregate is rock.

30. The method of claim 25, wherein the method can repeat a plurality of times, the second batch replacing the first batch and being associated with a second concrete receiving truck and a second quantity of large aggregate.

31. The method of claim 25, wherein the discharging from the translating means is at an elevated pressure.

32. The method of claim 31, wherein the discharging from the translating means is at a flow rate of at least approximately 3.6 cubic feet per second.

33. The method of claim 30, wherein the time between the discharging of the first batch to the first concrete receiving truck and the discharging of the second batch to the second concrete receiving truck is no greater than 70 seconds.

34. The method of claim 33, wherein the concrete is high-strength concrete.

35. The method of claim 25, wherein proportions of cement, water, and aggregate can be modified for each batch.

36. The method of claim 35, further comprising the step of monitoring moisture content in the aggregate.

37. The method of claim 36, wherein the proportions can be immediately adjusted to preserve a desired percentage by mass of water.

38. The method of claim 37, wherein a predetermined moisture content is achieved to an accuracy of approximately 0.2%.
